(19) United States
(12) Patent Application Publication
(10) Pub. No.: US 2013/0173410 A1
(43) Pub. Date: Jul. 4, 2013

(54) Method, System and Program Product for Operation and Management of Applications

(71) Applicant: Daymeon L. Sanders, Willingboro, NJ (US)

(72) Inventor: Daymeon L. Sanders, Willingboro, NJ (US)

(21) Appl. No.: 13/341,050

(22) Filed: Dec. 30, 2011

(51) Int. Cl. G06F 15/16; G06Q 30/08

(52) U.S. Cl. 705/26.3; 709/217; 705/26.1

(57) ABSTRACT

A method, system and program product comprises accessing, from a local computing device, a group of computing devices over a network. An application owned by a first user is transferred to the group for storage within the group in which the application is entered into a play list for the first user, the application is available from the play list for operation by the first user using a computing device compatible with the application, the application is available for swapping with a second user, the application is available for switching with a second user and the application is available for sale by the first user. Copies of the application are deleted from the local computing device.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to communication systems. More particularly, one or more embodiments of the invention relate to communication systems supporting operation and management of gaming applications.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

User/operators of video games often lose interest in respective video games and seek to sell or trade their video games for other video games.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a communication system, in accordance with an embodiment of the present invention;

FIGS. 2-3 illustrate an example method for the communication system as described with reference to FIG. 1, in accordance with an embodiment of the present invention;

FIG. 4 illustrates a typical computer system that, when appropriately configured or designed, may serve as a computer system for which the present invention may be embodied; and

FIG. 5 illustrates a block diagram depicting a conventional cloud communication system.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

Embodiments of the present invention will be described which provides an application for swapping (i.e. temporarily transferring operational rights), switching (i.e. transferring ownership), selling and operating applications. Embodiments of the present invention may provide an application for swapping, switching, selling and operating gaming applications. Embodiments of the present invention may provide an application for swapping, switching, selling and operating entertainment applications such as, but not limited to eBooks, digital music, digital movies, digital video program, etc. Embodiments of the present invention may provide an application for selling applications in an auction style environment. Embodiments of the present invention may provide an application for publishers and developers to receive credit for resale of their applications. Embodiments of the present invention may provide an application in which users never have to worry about retrieving a swapped application from a friend as the application is automatically returned to the user after a determined period of time. Embodiments of the present invention may provide an application for online social community in which users may chat and arrange for swapping, switching, selling and operating multi user applications. Embodiments of the present invention may provide an application for enabling a user to access applications from any compatible device in communication with a network. Embodiments of the present invention may provide an application for enabling the user to store applications on storage devices in communication with the network freeing storage space on the user's computing device. Embodiments of the present invention may provide an application for on demand accessing of applications. Embodiments of the present invention may provide an application for using a virtual hard drive in communication with the network for operating the application.

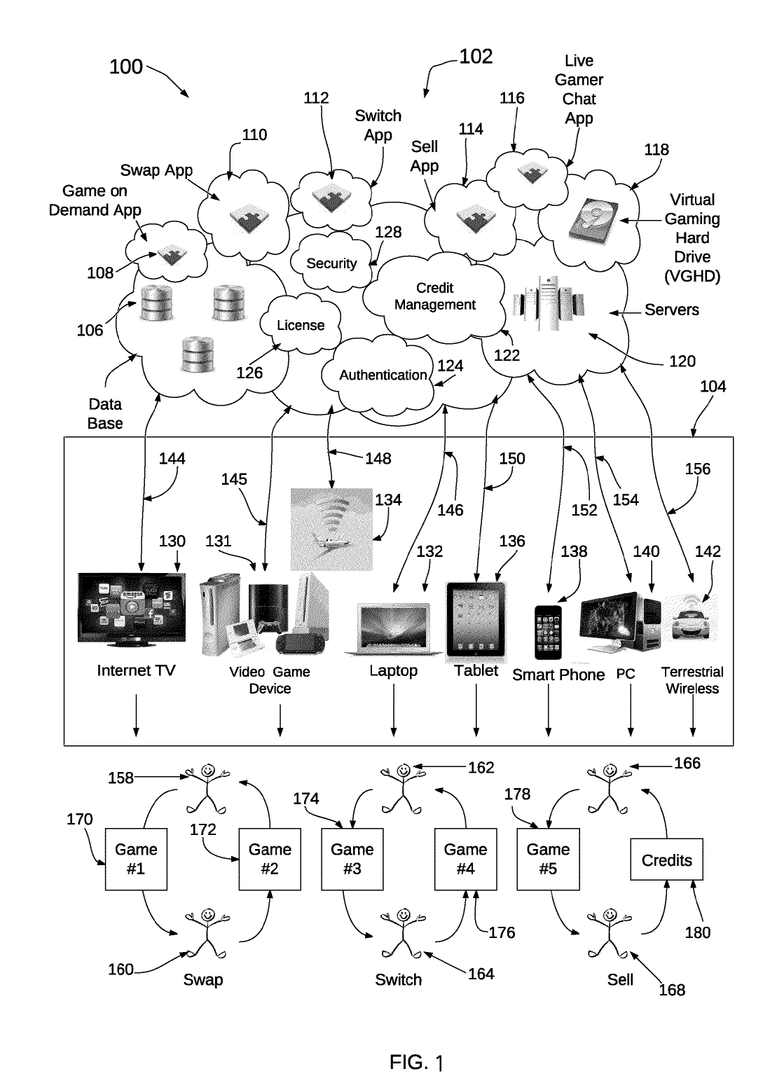

Embodiments of the present invention will now be described in detail with reference to FIGS. 1-5.

FIG. 1 is a diagram of a communication system, in accordance with an embodiment of the present invention.

A communication system 100 includes a computing/communications network 102 and a computing devices portion 104.

Communication system 100 provides capability for receiving, storing, retrieving, processing and presenting information. As a non-limiting example, communication system 100 may be configured for providing client/server as well as cloud-based peer-to-peer applications for swapping, switching, selling and/or operating digital videogames on demand.

Computing/communications network 102 provides computing resources and a communications network for receiving, storing, retrieving and processing information.

Computing devices portion 104 provides computing resources for receiving, storing, retrieving, processing and presenting information.

Computing/communications network 102 includes a database 106, a game on demand application 108, a swap application 110, a switch application 112, a sell application 114, a chat application 116, a multiplicity of virtual gaming hard drives with a sampling noted as a virtual gaming hard drive 118, a server portion 120, a credit management portion 122, an authentication portion 124, a license portion 126 and a security portion 128.

Database 106 receives, stores, retrieves and processes information.

Game on demand application 108 provides application for providing operation of games.

Swap application 110 provides capability for swapping games between users. A swap operation is considered a temporary exchange of games where gaming applications revert back to the owner following a period of time.

Switch application 112 provides capability for switching games between users. A switch operation is considered an operation where ownership of an application is converted from a first user to a second user.

Sell application 114 provides capability for a user to sell a game to another user.

Chat application 116 provides capability for users to communicate via chat sessions. Via chat, users can bi-directionally communicate text, audio and/or video information.

Virtual gaming hard drive 118 provides storage and programming instructions for operation of games.

Server portion 120 provides resources for operation of computing/communications network 102.

Credit management portion 122 provides management for credit. As a non-limiting example, a credit may represent a unit of value which may be used for making purchases.

Authentication portion 124 provides authentication processing to verify a game is authentic.

License portion 126 provides processing for determining whether a license key is a match or not a match.

Security portion 128 provides security processing. As a non-limiting example, security processing may search games for computer viruses. Furthermore, security portion 128 may provide capability for removal of computer viruses.

Computing devices portion 104 includes an Internet television 130, a video game device 131, a laptop computing device 132, an airborne wireless transceiver 134, a tablet computing device 136, a smartphone device 138, a computing device 140 and a terrestrial wireless transceiver 142.

Internet television 130 provides for receipt, storage, transmission, processing and presentation of information via a television interface.

Video game device 131 provides for receipt, storage, transmission, processing and presentation of information associated with a tablet computing device.

Laptop computing device 132 provides for receipt, storage, transmission, processing and presentation of information via a laptop interface.

Airborne wireless transceiver 134 provides for receipt, storage, transmission, processing and presentation of information associated with an airborne transportation vehicle (e.g. airplane).

Tablet computing device 136 provides for receipt, storage, transmission, processing and presentation of information associated with a tablet computing device.

Smartphone device 138 provides for receipt, storage, transmission, processing and presentation of information associated with a smartphone device.

Computing device 140 provides for receipt, storage, transmission, processing and presentation of information associated with a computing device.

Terrestrial wireless transceiver 142 provides for receipt, storage, transmission, processing and presentation of information associated with a terrestrial transportation vehicle (e.g. automobile).

Computing/communications network 102 communicates bi-directionally with Internet television 130 via a communications channel 144, with video game device 131 via communications channel 145 with laptop computing device 132 via a communications channel 146 with airborne wireless transceiver 134 via a communications channel 148 with tablet computing device 136 via a communications channel 150 with smartphone device 138 via a communication channel 152 with computing device 140 via a communication channel 154 with terrestrial wireless transceiver 142 via a communication channel 156.

A user 158, a user 160, a user 162, a user 164, a user 166 and a user 168 utilize internet television 130, video game device 131, laptop computing device 132, airborne wireless transceiver 134, tablet computing device 136, smartphone device 138, computing device 140 and terrestrial wireless transceiver 142 for processing associated applications, management of processing associated applications and for communicating with computing/communications network 102. As a non-limiting example, processing associated applications include gaming applications.

User 158 initially operates a game application 170, user 160 operates/owns a game application 172, user 162 operates/owns a game application 174, user 164 operates/owns a game application 176, user 166 operates/owns a game application 178 and user 168 maintains a credits 180.

Game application 170, game application 172, game application 174, game application 176 and game application 178 enable users to perform gaming applications.

Credits 180 enables a user to exchange credits for purchasing, selling or switching game applications. Furthermore, credits 180 may be exchanged for currency.

In operation, user 158 and user 160 swap game application 170 and game application 172, respectively, such that user 158 operates game application 172 and user 160 operates game application 170. Following a period of time, the operation of game application 170 and game application 172 revert such that user 158 operates game application 170 and user 160 operates game application 172. Furthermore, the swap is performed via swap application 110.

Furthermore, user 162 and user 164 switch game application 174 and game application 176, respectively, such that user 162 operates game application 176 and user 164 operates game application 174. Furthermore, ownership of game application 174 resides with user 164 and ownership of game application 176 resides with user 162. Furthermore, the switch operation is performed via switch application 112.

Furthermore, user 166 transfers ownership of game application 178 to user 168 in exchange for credits 180 where user 168 operates and owns game application 178 and user 166 owns credits 180. Furthermore, the selling operation is performed via sell application 114 and credit management portion 122.

Furthermore, security, authentication, and license processing are performed for swapping, switching and selling of gaming applications via security portion 128, authentication portion 124 and credit management portion 122, respectively.

As a non-limiting example, security processing via security portion 128 performs virus processing where computer virus applications are removed or disarmed. A computer virus application is a computer program which can replicate itself and spread from one computing device to another.

As a non-limiting example, license processing via license portion 126 verifies a user owns a respective gaming application.

As a non-limiting example, authentication processing via authentication portion 124 verifies a gaming application is genuine and not a copy or fake.

Applications (e.g. game application 170) are supported via virtual gaming hard drives (e.g. virtual gaming hard drive 118) for operation and maintenance of gaming applications.

A user (e.g. user 158) may communicate with another user (e.g. user 160) using chat application 116. Users exchange text, audio and/or video for performing communications.

Database 106 and server portion 120 provide operations for supporting operations associated with communication system 100. Non-limiting examples of supporting operations associated with database 106 and server portion 120 include gaming operation, gaming upload, gaming download, swapping, switching and selling.

Game on demand application 108 provides capability for networked gaming operations where users may operate games.

Communication system 100 enables users to swap, switch, sell and operate digital video games on demand. As a non-limiting example, communication system 100 operates as peer-to-peer where the architecture is distributed where peers are equally privileged.

A user may access system via a subscription. Non-limiting examples for subscriptions types include free and paid.

Following subscription, users may download and install an application to a computing device (e.g. Internet television 130) for interfacing with communication system 100. Application operates via a cloud or client/server and may be accessed by a web browser and may be initiated via selection by a pointing device.

Users may upload applications (e.g. game application 170) to an associated game play list via their computing devices (e.g. computing device 140) computing/communications network 102.

Prior to upload to computing/communications network 102, applications are verified for license keys via license portion 126 and authenticity via authentication portion 124.

As gaming applications are transferred to computing/communications network 102, gaming applications are removed from computing devices (e.g. laptop computing device 132). As a non-limiting example, removal includes deleting the application from the hard drive associated with the computing device. Removal of gaming application from computing devices aids in preventing pirated copies of gaming applications.

Following upload of applications, users may operate gaming applications on demand by selecting a gaming application from an associated play list.

Users may swap applications via swap application 110. Swapping may be performed via contacts found via the gaming community provided via computing/communications network 102. Furthermore, swapping may be performed via social network platforms and external gaming communities. Swaps may be performed for a period of time after which gaming applications are returned to the respective owners and removed from the respective play lists. As a non-limiting example, gaming applications may be swapped for 5 days. When a swap is performed, the gaming application is removed from the play list of the original owner and added to the recipient. When the period of time has expired, the play lists revert back.

Users may switch applications via switch application 112 for users associated with computing/communications network 102. A switch operation transfers ownership of an application from a first user to a second user. Applications are transferred with license key in order to maintain proper ownership rights. When a switch is performed, the gaming application is removed from the play list of the original owner and added to the recipient.

A first user may sell an application to a second user via sell application 114. User in ownership of application may post for sale a respective game in play list to the community of users associated with computing/communications network 102. A second user may purchase application using credits using credit management portion 122 with first user receiving credits. Furthermore, first user may use credits for purchasing items or for exchanging credits for currency. Second user receives ownership of the application with the application being added to second user's play list. Furthermore, second user receives license key associated with application and a receipt documenting the transaction.

Users may purchase credits via the home page associated with credit management portion 122 or via the main application's profile page.

By uploading gaming applications to computing/communications network 102, users may free up digital storage space on computing devices portion 104.

FIG. 1 is a diagram of a communication system for swapping, switching, purchasing, selling and operating applications.

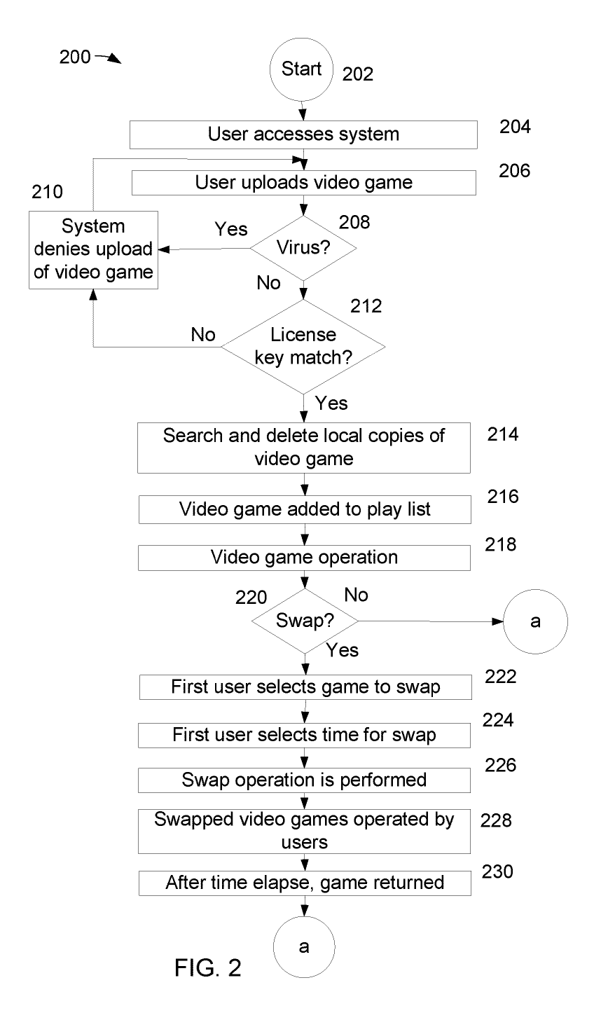

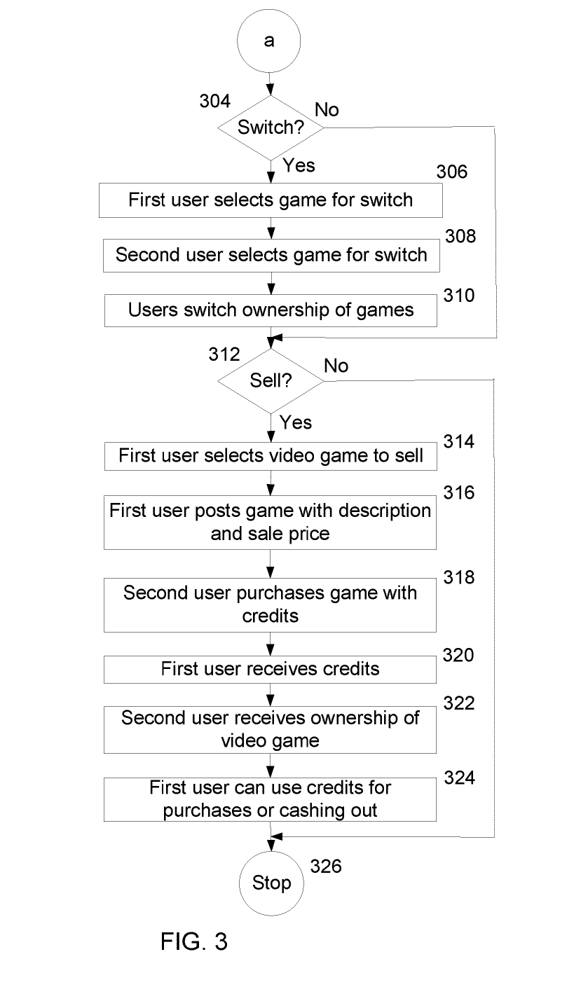

FIGS. 2-3 illustrate an example method for the communication system as described with reference to FIG. 1, in accordance with an embodiment of the present invention.

A method 200 initiates in a step 202.

Then in a step 204, user accesses communication system 100 (FIG. 1).

As a non-limiting example, a user may be presented with a prompt to enter user identification and password or for creating an account with an associated identification and password. Creation of an account may be provided for free or for some type of remuneration. Furthermore, user enters identification password for gaining access to communication system 100 (FIG. 1).

Referring back to FIG. 2, then in a step 206, user uploads video game to system.

As a non-limiting example, user uploads game from local computing device (e.g. tablet computing device 136 (FIG. 1)) to computing/communications network 102 (FIG. 1).

Referring back to FIG. 2, then in a step 208 determination for detecting potential harmful operational code (e.g. virus) is performed.

As a non-limiting example, security portion 128 (FIG. 1) processes uploaded game for detection of a virus.

Referring back to FIG. 2, for a determination of a virus in step 208, in a step 210, computing/communications network 102 (FIG. 1) rejects acceptance of uploaded video. Furthermore, following step 208, execution of method 200 transitions to step 206.

Referring back to FIG. 2, for a determination of no virus in step 208, in a step 212 a determination is performed for a license key match and authentication.

As a non-limiting example, license portion 126 (FIG. 1) verifies validity of license key for uploaded video game and authenticity of uploaded video game.

Referring back to FIG. 2, for a determination of no license match in step 212, execution of method 200 transitions to previously discussed step 210.

For a determination of a license match in step 212, in a step 214, system searches for and deletes local copies of uploaded video game.

As a non-limiting example, local copies of uploaded video game resident on smartphone device 138 (FIG. 1) are removed from smartphone device 138 (FIG. 1).

Referring back to FIG. 2, then in a step 216 video game is added to play list.

As a non-limiting example, uploaded video game is added to play list associated with computing/communications network 102 (FIG. 1).

Referring back to FIG. 2, then in a step 218 user may operate gaming application.

As a non-limiting example, user accesses uploaded video game via game on demand application 108 (FIG. 1) and local computing device (e.g. laptop computing device 132 (FIG. 1)).

Referring back to FIG. 2, then in a step 220 determination for a swap is performed.

For a determination of performing a swap in step 220, in a step 222, a first user selects a game to swap.

As a non-limiting example, user selects a video game to swap (e.g. game application 170 (FIG. 1)).

Referring back to FIG. 2, then in a step 224 first user selects time frame for swap.

As a non-limiting example, user select time frame of 5 days for swap via swap application 110 (FIG. 1).

Referring back to FIG. 2, then in a step 226 a swap operation is performed.

As a non-limiting example, operation capability for game application 170 (FIG. 1) is transferred from user 158 (FIG. 1) to user 160 (FIG. 1) and operation capability for game application 172 (FIG. 1) is transferred from user 160 (FIG. 1) to user 158 (FIG. 1). Furthermore, timeframe for swap is 5 days, after which operational capability will revert back to the condition prior to the swap.

Referring back to FIG. 2, then in a step 228 swapped video games are operated by the users.

As a non-limiting example, user 158 (FIG. 1) operates game application 172 (FIG. 1) and user 160 (FIG. 1) operates game application 170 (FIG. 1).

Referring back to FIG. 2, then in a step 230 time elapses for swap and operational control of game application is returned to the condition prior to the swap.

As a non-limiting example, user 158 (FIG. 1) loses operational control of game application 172 (FIG. 1) and regains operational control of game application 170 (FIG. 1). Furthermore, user 160 (FIG. 1) loses operational control of game application 170 (FIG. 1) and regains operational control of game application 172 (FIG. 1).

Following execution of step 230 and for a determination of not performing a swap in step 220, execution of method 200 transitions to a step 304 described with reference to FIG. 3.

In step 304, determination for a switch is performed.

For a determination of a switch in step 304, in a step 306 first user selects video game for switch.

As a non-limiting example, user 162 (FIG. 1) selects game application 174 (FIG. 1) for performing a switch with another user.

Referring back to FIG. 3, then in a step 308 second user selects video game for switching with another user.

As a non-limiting example, user 164 (FIG. 1) selects game application 176 (FIG. 1) for performing a switch with another user.

Referring back to FIG. 3, then in a step 310 user perform a switch of ownership.

As a non-limiting example, user 162 (FIG. 1) transfers ownership of game application 174 (FIG. 1) to user 164 (FIG. 1) and user 164 (FIG. 1) transfers ownership of game application 176 (FIG. 1) to user 162 (FIG. 1). Furthermore, switch operation is performed by switch application 112 (FIG. 1).

Referring back to FIG. 3, following execution of step 310 and for a determination of not switching in step 304, execution of method 200 transitions to a step 312.

In step 312, a determination for selling a video game is performed.

As a non-limiting example, a user may select a video game to sell to another user in exchange for credits.

In a step 314, first user selects video game to sell.

As a non-limiting example, user 166 (FIG. 1) selects game application 178 (FIG. 1) to sell.

Referring back to FIG. 3, then in a step 316 first user posts video game for sale with description and sale price.

As an example, user 166 (FIG. 1) posts game application 178 (FIG. 1) for sale via sell application 114 (FIG. 1).

Referring back to FIG. 3, then in a step 318 second user purchases video game using credits.

As an example, user 168 (FIG. 1) purchases game application 178 (FIG. 1) from user 166 (FIG. 1) via sell application 114 (FIG. 1) and credit management portion 122 (FIG. 1) using credits 180 (FIG. 1).

Referring back to FIG. 3, then in a step 320 first user receives credits for selling video game.

As a non-limiting example, user 166 (FIG. 1) receives credits 180 (FIG. 1) via sell application 114 (FIG. 1) and credit management portion 122 (FIG. 1) in exchange for selling game application 178 (FIG. 1) to user 168 (FIG. 1). Game application 178 (FIG. 1) is removed from the play list for user 166 (FIG. 1) such that user 166 (FIG. 1) is not provided operation privileges for game application 178 (FIG. 1).

Referring back to FIG. 3, then in a step 322 second user receives ownership of video game.

As a non-limiting example, user 168 (FIG. 1) received ownership of game application 178 (FIG. 1) with game application 178 (FIG. 1) being added to the play list for user 168 (FIG. 1) such that user 168 (FIG. 1) may operate game application 178 (FIG. 1).

Referring back to FIG. 3, then in a step 324 first user may use received credits from sale of video game for purchase or for cashing out.

As a non-limiting example, user 166 (FIG. 1) may used received credits 180 for purchasing items available for purchase or may exchange credits 180 (FIG. 1) for currency.

Referring back to FIG. 3, following step 324 or for a determination of not selling an item in step 312, method 200 terminates execution in a step 326.

FIGS. 2-3 illustrate an example method for the communication system as described with reference to FIG. 1 where a user may swap, switch, sell and operate gaming applications.

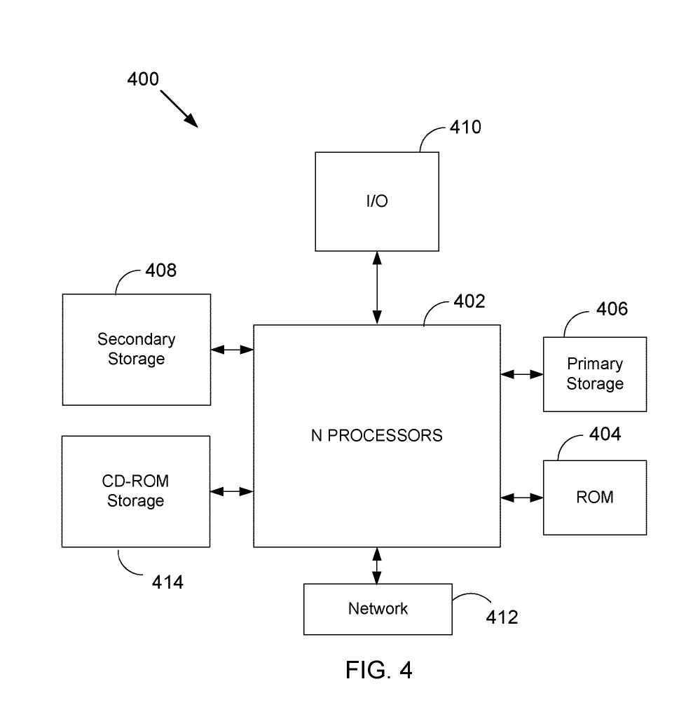

FIG. 4 illustrates a typical computer system that, when appropriately configured or designed, may serve as a computer system 400 for which the present invention may be embodied.

Computer system 400 includes a quantity of processors 402 (also referred to as central processing units, or CPUs) that may be coupled to storage devices including a primary storage 406 (typically a random access memory, or RAM), a primary storage 404 (typically a read-only memory, or ROM). CPU 402 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 404 acts to transfer data and instructions uni-directionally to the CPU and primary storage 406 typically may be used to transfer data and instructions in a bi-directional manner. The primary storage devices discussed previously may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and typically may be used as a secondary storage medium such as a hard disk. It will be appreciated that the information retained within mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection shown generally as a network 412, which may be implemented as a hardwired or wireless communications link using suitable conventional technologies. With such a connection, the CPU might receive information from the network, or might output information to the network in the course of performing the method steps described in the teachings of the present invention.

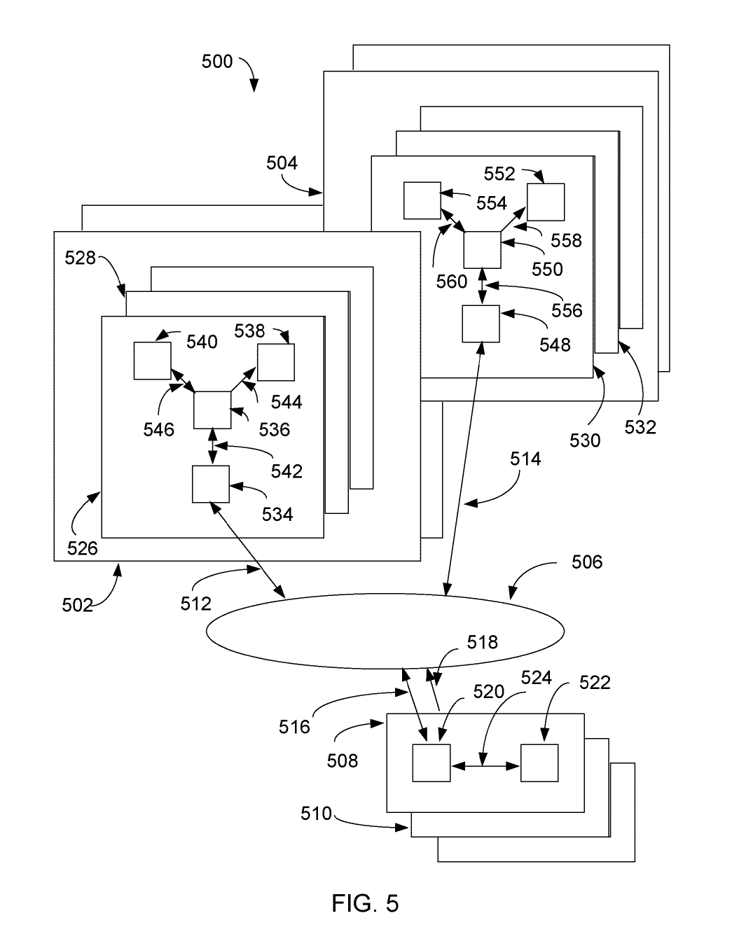

FIG. 5 illustrates a block diagram depicting a conventional cloud communication system.

A communication system 500 includes a multiplicity of networked regions with a sampling of regions denoted as a network region 502 and a network region 504, a global network 506 and a multiplicity of servers with a sampling of servers denoted as a server device 508 and a server device 510.

Network region 502 and network region 504 may operate to represent a network contained within a geographical area or region. Non-limiting examples of representations for the geographical areas for the networked regions may include postal zip codes, telephone area codes, states, counties, cities and countries. Elements within network region 502 and 504 may operate to communicate with external elements within other networked regions or within elements contained within the same network region.

In some implementations, global network 506 may operate as the Internet. It will be understood by those skilled in the art that communication system 500 may take many different forms. Non-limiting examples of forms for communication system 500 include local area networks (LANs), wide area networks (WANs), wired telephone networks, cellular telephone networks or any other network supporting data communication between respective entities via hardwired or wireless communication networks. Global network 506 may operate to transfer information between the various networked elements.

Server device 508 and server device 510 may operate to execute software instructions, store information, support database operations and communicate with other networked elements. Non-limiting examples of software and scripting languages which may be executed on server device 508 and server device 510 include C, C++, C# and Java.

Network region 502 may operate to communicate bi-directionally with global network 506 via a communication channel 512. Network region 504 may operate to communicate bi-directionally with global network 506 via a communication channel 514. Server device 508 may operate to communicate bi-directionally with global network 506 via a communication channel 516. Server device 510 may operate to communicate bi-directionally with global network 506 via a communication channel 518. Network region 502 and 504, global network 506 and server devices 508 and 510 may operate to communicate bi-directionally and also communicate bi-directionally with other networked device located within communication system 500.

Server device 508 includes a networking device 520 and a server 522. Networking device 520 may operate to communicate bi-directionally with global network 506 via communication channel 516 and with server 522 via a communication channel 524. Server 522 may operate to execute software instructions and store information.

Network region 502 includes a multiplicity of clients with a sampling denoted as a client 526 and a client 528. Client 526 includes a networking device 534, a processor 536, a GUI 538 and an interface device 540. Non-limiting examples of devices for GUI 538 include monitors, televisions, cellular telephones, smartphones and PDAs (Personal Digital Assistants). Non-limiting examples of interface device 540 include pointing device, mouse, trackball, scanner and printer. Networking device 534 may communicate bi-directionally with global network 506 via communication channel 512 and with processor 536 via a communication channel 542. GUI 538 may receive information from processor 536 via a communication channel 544 for presentation to a user for viewing. Interface device 540 may operate to send control information to processor 536 and to receive information from processor 536 via a communication channel 546. Network region 504 includes a multiplicity of clients with a sampling denoted as a client 530 and a client 532. Client 530 includes a networking device 548, a processor 550, a GUI 552 and an interface device 554. Non-limiting examples of devices for GUI 538 include monitors, televisions, cellular telephones, smartphones and PDAs (Personal Digital Assistants). Non-limiting examples of interface device 540 include pointing devices, mousse, trackballs, scanners and printers. Networking device 548 may communicate bi-directionally with global network 506 via communication channel 514 and with processor 550 via a communication channel 556. GUI 552 may receive information from processor 550 via a communication channel 558 for presentation to a user for viewing. Interface device 554 may operate to send control information to processor 550 and to receive information from processor 550 via a communication channel 560.

For example, consider the case where a user interfacing with client 526 may want to execute a networked application. A user may enter the IP (Internet Protocol) address for the networked application using interface device 540. The IP address information may be communicated to processor 536 via communication channel 546. Processor 536 may then communicate the IP address information to networking device 534 via communication channel 542. Networking device 534 may then communicate the IP address information to global network 506 via communication channel 512. Global network 506 may then communicate the IP address information to networking device 520 of server device 508 via communication channel 516. Networking device 520 may then communicate the IP address information to server 522 via communication channel 524. Server 522 may receive the IP address information and after processing the IP address information may communicate return information to networking device 520 via communication channel 524. Networking device 520 may communicate the return information to global network 506 via communication channel 516. Global network 506 may communicate the return information to networking device 534 via communication channel 512. Networking device 534 may communicate the return information to processor 536 via communication channel 542. Processor 536 may communicate the return information to GUI 538 via communication channel 544. User may then view the return information on GUI 538.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of a communication system for gaming applications according to the present invention will be apparent to those skilled in the art. Although the description above is directed to an example for a gaming application, the teaching herein are applicable to any application such as, but not limited to, commercial applications, eBooks, digital music, digital movies, digital video program, etc. The invention has been described above by way of illustration, and the specific embodiments disclosed are not intended to limit the invention to the particular forms disclosed. For example, the particular implementation of the GUI may vary depending upon the particular type of computing device used. The computing devices described in the foregoing were directed to laptop computing device implementations; however, similar techniques using mobile computing device implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A non-transitory computer-readable storage medium with an executable program stored thereon, wherein the program instructs a processor to perform the following steps:
accessing, from a local computing device, a group of computing devices over a network;
transferring to the group an application owned by a first user for storage within the group in which the application is entered into a play list for the first user, the application is available from the play list for operation by the first user using a computing device compatible with the application, the application is available for swapping with a second user, the application is available for switching with a second user and the application is available for sale by the first user; and
deleting copies of the application from the local computing device.

2. The program instructing the processor as recited in claim 1, in which ownership of the application is verified.

3. The program instructing the processor as recited in claim 1, in which the application is processed to determine if the application contains harmful instructions.

4. The program instructing the processor as recited in claim 1, further comprising the step of establishing a communication between the first user and the second user for swapping the application with a second user's application for a determined amount of time.

5. The program instructing the processor as recited in claim 4, in which the communication is established via a chat function of the group.

6. The program instructing the processor as recited in claim 4, further comprising the step of instructing a swap of the application with the second user's application in which the application is removed from the play list of the first user and added to a play list of the second user, and the second user's application is removed from the play list of the second user and added to the play list of the first user for the determined amount of time.

7. The program instructing the processor as recited in claim 1, further comprising the step of instructing a switch of the application with the second user's application in which ownership of the application and the second user's application are exchanged, the application is removed from the play list of the first user and added to a play list of the second user, and the second user's application is removed from the play list of the second user and added to the play list of the first user.

8. The program instructing the processor as recited in claim 1, further comprising the step of instructing a sale of the application to the second user in which ownership of the application is transferred to the second user for a credit transfer from the second user to the first user, the application is removed from the play list of the first user and added to a play list of the second user.

9. The program instructing the processor as recited in claim 1, further comprising the step of engaging in an auction style environment for the sale of the application.

10. The program instructing the processor as recited in claim 1, in which the application comprises a gaming application.

11. A computer-implemented system comprising:
a group of computing devices forming a network, said group comprising at least a data base, a server portion, a credit management portion, an authentication portion, a license portion and a security portion;
a local computing device being configured for communication with said group and being configured for transferring to said group an application owned by a first user for storage within said group and deleting copies of the application from said local computing device, in which the application is entered into a play list for the first user, the application is available from the play list for operation by the first user using a computing device compatible with the application, the application is available for swapping with a second user, the application is available for switching with a second user and the application is available for sale by the first user.

12. The system as recited in claim 11, in which ownership of the application is verified by said group.

13. The system as recited in claim 11, in which the application is processed by said group to determine if the application contains harmful instructions.

14. The system as recited in claim 11, in which said group is configured to establish a communication between the first user and the second user for swapping the application with a second user's application for a determined amount of time.

15. The system as recited in claim 14, in which the communication is established via a chat function of said group.

16. The system as recited in claim 11, in which said group is configured to swap the application with the second user's application in which the application is removed from the play list of the first user and added to a play list of the second user, and the second user's application is removed from the play list of the second user and added to the play list of the first user for the determined amount of time.

17. The system as recited in claim 11, in which said group is configured to switch the application with the second user's application in which ownership of the application and the second user's application are exchanged, the application is removed from the play list of the first user and added to a play list of the second user, and the second user's application is removed from the play list of the second user and added to the play list of the first user.

18. The system as recited in claim 11, in which said group is configured to sell the application to the second user in which ownership of the application is transferred to the second user for a credit transfer from the second user to the first user, the application is removed from the play list of the first user and added to a play list of the second user.

19. The system as recited in claim 11, in which said group and said local computing device are configured for engaging in an auction style environment for the sale of the application.

20. A non-transitory program storage device readable by a machine tangibly embodying a program of instructions executable by the machine to perform a method for operation and management of gaming applications, comprising computer code for:
accessing, from a local computing device, a group of computing devices over a network;
transferring to the group a gaming application owned by a first user for storage within the group in which ownership of the gaming application is verified, the gaming application is processed to determine if the gaming application contains harmful instructions, the gaming application is entered into a play list for the first user, the gaming application is available from the play list for operation by the first user using a computing device compatible with the gaming application, the gaming application is available for swapping with a second user, the gaming application is available for switching with a second user and the gaming application is available for sale by the first user;
deleting copies of the gaming application from the local computing device;
establishing a communication between the first user and the second user for swapping or switching the gaming application with a second user's gaming application, in which the communication is established via a chat function of the group;
instructing a swap of the gaming application with the second user's gaming application in which the gaming application is removed from the play list of the first user and added to a play list of the second user, the second user's gaming application is removed from the play list of the second user and added to the play list of the first user for a determined amount of time, and the first user's play list and the second user's play list are restored upon expiration of the determined amount of time;
instructing a switch of the gaming application with the second user's gaming application in which ownership of the gaming application and the second user's gaming application are exchanged, the gaming application is removed from the play list of the first user and added to a play list of the second user, and the second user's gaming application is removed from the play list of the second user and added to the play list of the first user;
instructing a sale of the gaming application to the second user in which ownership of the gaming application is transferred to the second user for a credit transfer from the second user to the first user, the gaming application is removed from the play list of the first user and added to the play list of the second user; and
engaging in an auction style environment for sale of the gaming application.
